(19) United States
(12) Patent Application Publication
(10) Pub. No.: US 2013/0099744 A1
(43) Pub. Date: Apr. 25, 2013

(54) METHOD AND CONTROL UNIT FOR CHARGING A VEHICLE BATTERY

(71) Applicants: Rainer Falk, Poing (DE); Steffen Fries, Baldham (DE)

(72) Inventors: Rainer Falk, Poing (DE); Steffen Fries, Baldham (DE)

(73) Assignee: Siemens Aktiengesellschaft, München (DE)

(21) Appl. No.: 13/809,167

(22) PCT Filed: Jun. 29, 2011
(86) PCT No.: PCT/EP2011/060876

§ 371 Date: Jan. 9, 2013

(30) Foreign Application Priority Data
Jul. 9, 2010 (DE) 10 2010 026 689.2

(51) Int. Cl. H02J 7/00

(52) U.S. Cl. CPC H02J 7/0052
USPC 320/109; 320/137

(57) ABSTRACT

A vehicle battery is charged by an authorized charging station. A first cryptographically protected communication link is set up between a charging control unit of the vehicle and the charging station after successful preliminary verification of a digital certificate for the charging station by the charging control unit of the vehicle. A second communication link is then set up between the charging control unit and an authorization server for charging stations. The charging control unit transmits information from the preliminarily verified digital certificate to the authorization server via the second communication link, which information is used by the authorization server to carry out an authorization check on the respective charging station. An authorization check result is transmitted from the authorization server to the charging control unit via the second communication link, which result is used to control a charging of the vehicle battery.

### CROSS REFERENCE TO RELATED APPLICATIONS

This application is based on and hereby claims priority to International Application No. PCT/EP2011/060876 filed on Jun. 29, 2011 and German Application No. 10 2010 026 689.2 filed on Jul. 9, 2010, the contents of which are hereby incorporated by reference.

### BACKGROUND

The invention relates to a method and a control unit for charging an accumulator in an electric vehicle by an authorized charging station.

Electric vehicles can have one or more accumulators which store a charge, with the help of which an electric motor is driven. In the operation of the vehicle, the electric vehicle's accumulator is discharged, and must be recharged. For this purpose, the electric vehicle is connected to a charging column which is linked to an electricity supply network, wherein the charging column supplies the energy required to charge up the accumulator. The vehicle can be charged up via an electric cable or by induction coils. The charging columns can be located, for example, on parking lots for parking vehicles, or at the sides of roads. The driver of an electric vehicle, in which the built-in accumulator needs to be charged up, connects the electric vehicle to an electric charging column located at the side of a road or at a gas station, for example, for the purpose of charging it up. Unlike gasoline pumps, electric charging columns can be located not only at gas stations but also at a host of other possible installation sites, in particular parking garages and parking lots. Particularly in these cases, the driver may not know who operates the charging column concerned, and from which electricity supplier he is actually drawing the power required.

There is therefore a danger that charging columns are erected which have been manipulated by third parties, or that existing charging columns have been tampered with, so that the accumulator in the vehicle is charged up with a smaller amount of electricity or amount of charge than the driver is informed of by the charging column.

### SUMMARY

It is therefore one potential object to provide a method and a control device for charging up an accumulator in a vehicle which increase the security against such types of manipulations.

The inventors propose a method for the charging up of an accumulator in a vehicle by an authorized charging station comprising the steps:
After the successful provisional verification of a digital certificate for the charging station by a charging control unit in the vehicle, set up a first cryptographically protected communication link between the charging control unit in the vehicle and the charging station;
Set up a second communication link between the charging control unit in the vehicle and an authorization server for charging stations;
Send the provisionally verified digital certificate for the charging station, or an item of checking data extracted from it, from the charging control unit in the vehicle, via the second communication link which has been set up, to the authorization server for charging stations, by reference to which the authorization server carries out an authorization check on the charging station concerned, and
Send an authorization check result from the authorization server via the second communication link to the vehicle's charging control unit which controls a charging operation, for the charging of the vehicle's accumulator by the charging station, as a function of the authorization check result which it has received.

With one embodiment of the method, the first communication link is cryptographically protected by TLS, SSL or IPsec.

With one possible embodiment of the method, the second communication link between the vehicle's charging control unit and the authorization server is set up via the charging station.

With this embodiment, use is made of the fact that the charging station commonly has available a data link to a data network, in particular to the internet.

With one possible embodiment of the method, the second communication link between the vehicle's charging control unit and the authorization server is set up in tunneled form via the first communication link, which exists between the vehicle's charging control unit and the charging station.

With one possible embodiment of the method, the second communication link between the vehicle's charging control unit and the authorization server is also cryptographically protected.

With one possible embodiment of the method, the authorization check result sent from the authorization server to the vehicle's charging control unit has filtering rules for the data communications via the first communication link between the vehicle's charging control unit and the charging station.

Instead of the filtering rules themselves, with one possible embodiment it is possible to transmit control signals or control data, as appropriate, for the activation of such types of filtering rules by the vehicle's charging control unit. These filtering rules could, for example, be filed in a data store in the vehicle, to which the vehicle's charging control unit has access.

With one possible embodiment of the method, the authorization check result sent from the authorization server to the vehicle's charging control unit has charging control rules to control the charging operation for the charging of the vehicle by the charging station. As an alternative to the charging rules themselves, control data or control signals, as appropriate, for the activation by the vehicle's charging control unit of charging rules of this type, could also be transmitted via the second communication link from the authorization server to the vehicle's charging control unit. These charging rules can also be located in a data store in the vehicle, to which the vehicle's charging control unit has access.

With one possible embodiment of the method, the charging control unit charges an accumulator contained in the vehicle, as a function of the charging rules which have been received or of the locally activated charging rules, by electrical energy transmitted from the charging station to the vehicle.

With one possible embodiment of the method, the charging station charges the vehicle's accumulator through a charging cable which is connected to an electrical connection on the vehicle.

With one alternative embodiment, the charging station charges the vehicle's accumulator by inductive energy transmission using induction coils.

With one possible embodiment of the method, the first communication link between the vehicle's charging control unit and the charging station is established through an electric charging cable, using Power Line Communication (PLC).

With an alternative embodiment of the method, the first communication link between the vehicle's charging control unit and the charging station is established via a data line which runs parallel to the charging cable or is integrated into the charging cable and runs parallel to a charging line, as applicable.

With another possible embodiment of the method, the first communication link between the vehicle's charging control unit and the charging station is established via a radio interface, for example WLAN.

The inventors also propose a charging control unit for a vehicle, for the charging of an accumulator in the vehicle by a charging station authorized for doing so, with a calculation unit for the provisional verification of a digital certificate for the charging station, received from the charging station, wherein the charging control unit transmits the provisionally verified certificate, or an item of check data extracted from it, to an authorization server for the determination of an authorization check result, which the charging control unit receives from the authorization server, wherein the charging control unit controls a charging operation, for the charging of the vehicle's accumulator by the charging station, as a function of the authorization check result which has been received.

With one embodiment of the charging control unit, in a charging procedure controlled by the charging control unit the charging station charges an accumulator in the vehicle, through a charging cable or by inductive energy transmission, in accordance with charging rules which are transmitted from the authorization server to the charging control unit together with the authorization check result, or which are activated by the charging control unit by control data transmitted together with the authorization check result.

With one possible embodiment of the charging control unit, the first communication link between the vehicle's charging control unit and the charging station is via a charging cable, wherein the data transmission is effected by Powerline Communication PLC.

With an alternative embodiment, the first communication link between the vehicle's charging control unit and the charging station is via a data line which runs parallel to the charging cable or is integrated into the charging cable and runs parallel to a charging line, as applicable.

With another possible embodiment of the charging control unit, the first communication link between the vehicle's charging control unit and the charging station is via a radio interface, in particular WLAN.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 a flow diagram to show one possible embodiment of the proposed method;

FIG. 2 a signal diagram to show one way in which the method functions;

FIG. 3 a block diagram to show the way in which the proposed charging control unit functions.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

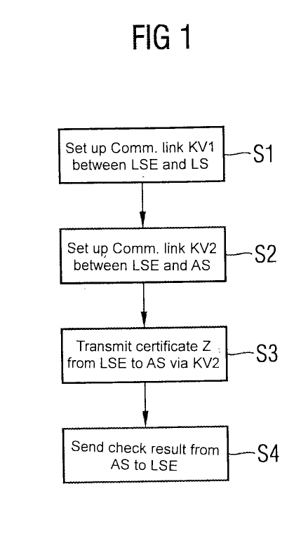

As one can see from FIG. 1, the proposed method for the charging of a vehicle, by a charging station authorized for the purpose, has four important parts, SI to S4.

In a first step SI, after the charging control unit LSE of the vehicle F has successfully effected a provisional verification of a digital certificate Z for the charging station LS a first cryptographically protected communication link KV1 is set up between a charging control unit LSE of the vehicle F and the charging station LS. With one possible embodiment, the vehicle initially logs into the charging station LS using a User ID for the vehicle or the vehicle owner, and the charging station LS is initially unilaterally authenticated. For this purpose, the vehicle receives from the charging station LS a digital certificate Z for the charging station LS, which is checked at the vehicle's charging control unit LSE. The vehicle can, for example using IKE/IPsec or TLS, set up a protected or cryptographically protected communication link, as appropriate, to the charging column LS, which authenticates itself to the vehicle by the digital certificate after the certificate Z has been successfully verified. In an alternative variant, the vehicle transmits the User ID of the vehicle or the vehicle owner only after the cryptographically protected communication link KV1 to the charging station LS has been set up using the verified certificate Z for the charging station LS.

The setting up of the cryptographically protected link KV1 to the charging station is in this way successfully completed, i.e. the IKE protocol or the TLS protocol, as applicable, is successfully concluded and the charging station is treated by the vehicle as being successfully authenticated even though the certificate for the charging column has not yet been finally checked by the vehicle.

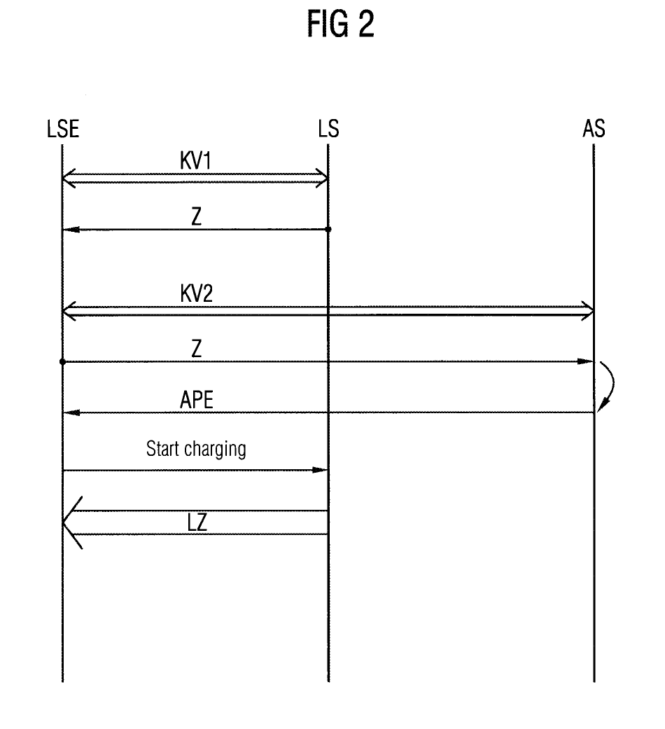

In a second step S2, a second communication link KV2 is set up between the vehicle's charging control unit LSE and an authorization server AS for the charging stations, as is also shown in FIG. 2. With one possible embodiment, this second communication link KV2 between the vehicle's charging control unit LSE and the authorization server AS is set up via the charging station LS. In this case, the charging station LS is linked to the authorization server AS via a data network, for example the internet. In another embodiment, the second communication link KV2 between the vehicle's charging control unit LSE and the authorization server AS is set up in tunneling mode via the first communication link KV1, which already exists between the charging control unit LSE of the vehicle F and the charging station LS. This tunneled link thus forms a section of the second communication link KV2, as shown in FIG. 2.

With an alternative embodiment, the second communication link KV2 can be set up as a separate data link to the authorization server AS. For example, if a radio module is provided in the vehicle F the second communication link KV2 can, for example, be set up to the authorization server AS via a mobile radiocommunication access network and an appropriate backend network. With this embodiment, the second communication link KV2 then does not pass through the charging station LS. This embodiment has the advantage that the security against manipulation of the charging station LS is further increased. With one possible embodiment, the second communication link KV2 between the charging station LSE of the vehicle F and the authorization server AS is also cryptographically protected.

As shown in FIG. 1, in a further step S3 the charging control unit LSE of the vehicle F sends or transmits the provisionally verified digital certificate Z for the charging station LS, or an item of checking data extracted from it, to the authorization server AS for charging stations over the second communication link KV2 which has been set up. At the authorization server AS, an authorization check is carried out on the charging station LS by reference to the checking data which has been received, or the certificate Z which has been received, as applicable. The authorization checker thus checks the validity of the digital certificate Z, and can check in addition whether the owner of the vehicle may use this charging station LS. With one possible embodiment, the authorization server AS is the authorization server of an electric power supplier. Further, the authorization server AS can be an authorization server of a clearing house, which bills for the electric power drawn by the customers of various electric power suppliers. If the provisionally verified digital certificate Z which has been received for the charging station LS really is valid, and if the vehicle owner is authorized to draw electric power from this charging station, the authorization server AS sends a corresponding authorization check result APE to the charging control unit LSE of the vehicle F, in a step S4. The charging control unit LSE of the vehicle F controls a charging operation, for the charging up of the vehicle by the charging station LS, as a function of the authorization check result APE which it has received. The authorization check result APE authorizes the charging operation at this charging station LS.

With the method, a first protected communication link KV1 is, as shown in FIGS. 1 and 2, set up between the charging control unit LSE of the vehicle F and the charging station LS, wherein it is only retrospectively that the security parameters, that is to say for example a digital certificate Z, is conclusively checked. The digital certificate Z for the charging station LS is provisionally verified at the charging control unit LSE end, but the application policy for the realized application, that is to say the charging operation, depends on the digital certificate Z, which is conclusively checked by the authorization server AS. One advantage of the method lies in the fact that data providing information about which charging stations LS may be used by the vehicle F, and what restrictions are to be observed in doing so, do not need to be kept available in a store in the vehicle F. In this manner, the administrative effort for the administration of data is significantly reduced. Furthermore, the danger of the data stored in the vehicle F becoming obsolete is avoided. With the method, there is a time delay respectively between carrying out the authentication or the authorization checking for the charging station LS and the subsequent authorization or issuing of rights. The time delay in authentication/authorization enables actions to be initiated via an existing cryptographically protected communication link, in particular a TLS link.

With one preferred embodiment of the method, the authorization check result APE, sent in step S3 from the authorization server AS to the charging control unit LSE of the vehicle F, has filtering rules FR for the data communications over the first communication link KV1 between the charging control unit LSE of the vehicle F and the charging station LS. Instead of the filtering rules themselves, it is also possible for the authorization server AS to transmit, via the second communication line KV2, control signals or control data, as appropriate, for the activation of such filtering rules FR by the charging control unit LSE within the vehicle F. In this case, the charging control unit LSE of the vehicle F will then read the activated filtering rules FR for the data communications out from a local data store in the vehicle F. The filtering rules FR can specify, for example, whether the communication link is permitted or blocked. Further possible filtering rules FR could relate to addresses, protocols or ports. It is further possible that the filtering rules FR contain application protocol filtering rules, for example permitted http or Web service commands.

With one further possible embodiment of the method, the authorization check result APE sent by the authorization server AS to the charging control unit LSE of the vehicle F has charging rules LR for controlling the charging operation for the charging of the vehicle F by the charging station LS. Instead of the charging rules LR themselves, the authorization server AS can also transmit to the charging control unit LSE of the vehicle F, via the second communication link KV2, control signals or control data, as appropriate, for activating charging rules LR of this type. In this case, the appropriate charging rules LR are activated locally by the charging control unit LSE as a function of the control signals it has received, for example in that they are read out from a local data store. With this embodiment, the charging control unit LSE charges an accumulator AK, which is contained in the vehicle F, as a function of the charging rules LR which have been received or activated, as applicable. The charging rules LR can specify, for example, the charging characteristics using which the accumulator AK in the vehicle F is charged. For example, the charging rules LR can specify a course over time for the charging operation. Using the charging rules LR it is possible to take into consideration the nature or type of the vehicle's accumulator AK during the charging operation, for example in order to prevent damage to or the destruction of the vehicle's accumulator AK, in particular in the case of over-rapid charging. After the charging control unit LSE of the vehicle F has received the authorization check result APE, including the filtering rules FR for the data communications and the charging rules LR for controlling the charging operation, in step S4, it can control the operation for the charging of the vehicle F by the charging station LS selectively as a function of the authorization check result APE which has been received. As shown in FIG. 2, the charging control unit LSE of the vehicle F sends to the charging station LS, via the first communication link KV1, an invitation to initiate a charging cycle LZ. During this charging cycle LZ the accumulator AK is charged up by the charging station LS using a current I or charge Q, as appropriate. With one possible embodiment, the amount of electric power drawn can be specified by a token provided by the authorization server AS.

With one possible embodiment, the charging control unit LSE confirms in signed form the amount of energy received from the charging station LS. With one possible embodiment, the amount of energy provided by the charging station LS in the charging cycle is reported to the authorization server AS by the charging station LS, in order to carry out billing.

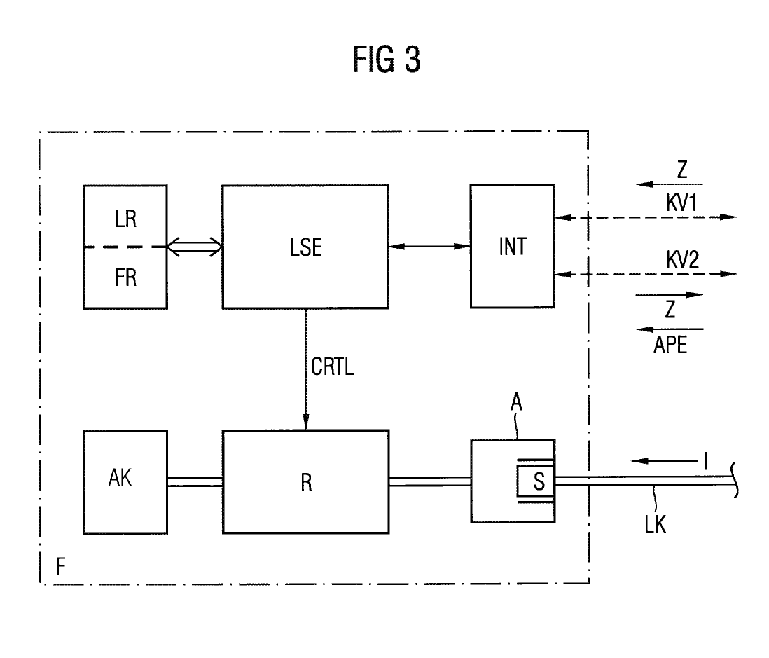

FIG. 3 shows a block diagram to explain the way in which an charging control unit LSE, which is located within a vehicle F, functions. The charging control unit LSE provides a calculation unit for the provisional verification of a digital certificate Z, received from a charging station LS. The charging control unit LSE is connected to a communication interface or an interface circuit, through which a data link can be set up to the charging station LS. Via this interface, the charging control unit LSE receives a digital certificate Z from the charging station LS, over the first communication link KV1. After the provisional verification of this digital certificate Z, then after a second communication link KV2 has been set up the charging control unit LSE sends this provisionally verified digital certificate Z to the authorization server AS via the same interface or another one. After receiving an authorization check result APE via the interface, the charging control unit LSE controls the charging operation for the charging of the accumulator AK in the vehicle F by the charging station LS. For this purpose the charging control unit LSE can, for example, actuate a charge regulator R which is available in the vehicle F, which is provided between a power connection A and the accumulator AK which is to be charged up. In the exemplary embodiment shown, a plug S on an electric charging cable LK from the charging station LS is plugged into the power connection A in the vehicle F. The current I supplied from the charging station LS via the electric charging cable LK passes through the power connection A and an electric lead to the current regulator or charging regulator R, as applicable, and charges the accumulator AK in the vehicle F as a function of a charging control signal CRTL. The charging up can be effected taking into account charging rules LR, which the charging control unit LSE reads out from a local data store in the vehicle F. In this data store there can also be, as shown in FIG. 3, the filtering rules FR for filtering the data communications over the first communication link KV1, between the charging control unit LSE of the vehicle F and the charging station LS. The charging control unit LSE can have one or more microprocessors for carrying out a corresponding charging program. The charging program can be located in a program memory.

In the case of the exemplary embodiment shown in FIG. 3, the energy is transmitted from the charging station LS to the accumulator AK through an electric charging cable LK. Alternatively, the current I can also be transmitted from the charging station LS to the charging regulator R by inductive coils.

In the case of the embodiment shown in FIG. 3, the two communication links KV1 and KV2 are set up through the same interface. With an alternative embodiment, the two communication links are set up through different, separate, data interfaces. With another possible embodiment, the first communication link KV1 is set up, as shown in FIG. 3, not through a data interface but via the charging cable LK, using Powerline Communication PLC. The first and second communication links can be set up through a wireless or a wired interface.

With one possible embodiment, the accumulator AK in the vehicle F shown in FIG. 3 is exchangeable. With one possible embodiment, the charging control unit LSE of the vehicle F can recognize the type of accumulator AK which is installed, for example by reference to an electronic identifier provided on the accumulator AK. The type of accumulator AK which has been recognized can be reported to the authorization server AS for the purpose of selecting the charging rules LR. The charging rules LR are either transmitted to the vehicle F by the authorization server AS together with the authorization check result APE, over the second communication link KV2, or are read out from the local data store by the charging control unit LSE after receipt of an appropriate selection instruction.

With one possible embodiment of the charging control unit LSE, this charging control unit LSE is integrated into an exchangeable accumulator AK in the vehicle F. With one possible embodiment, this vehicle accumulator also has, apart from its storage cells, a charging regulator R and a charging control unit LSE, which has available a data interface. The proposals thus provide an intelligent vehicle accumulator AK with an integral charging control unit LSE for the charging of the vehicle's accumulator AK by a charging station LS authorized for this purpose. This vehicle accumulator AK can be installed in various types of vehicle F, for example motor vehicles, in particular cars, heavy goods vehicles or buses. In the case of the electric vehicle F this could also be, for example, a golf buggy. Furthermore, the vehicle F could also be an electric water craft or an electric rail vehicle. The method and the charging control unit LSE can thus be used in a wide variety of ways.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-16. (canceled)

17. A method for charging an accumulator in a vehicle by an authorized charging station, comprising:
performing a provisional verification, by a charging control device of the vehicle, of a digital certificate for the charging station;
after a successful provisional verification, setting up a first communication link between the charging control device of the vehicle and the charging station, the first communication link being cryptographically protected;
setting up a second communication link between the charging control device of the vehicle and an authorization server for charging stations;
sending information from the digital certificate for the charging station, from the charging control device of the vehicle to the authorization server for charging stations over the second communication link, by reference to which the authorization server caries out an authorization check for the charging station; and
sending an authorization check result from the authorization server over the second communication link to the charging control device of the vehicle; and
controlling a charging operation, for charging of the accumulator in the vehicle by the charging station, as a function of the authorization check result from the authorization server.

18. The method as claimed in claim 17, wherein the first communication link is cryptographically protected by at least one of transport layer security (TLS), secure sockets layer (SSL) and internet protocol security (IPsec).

19. The method as claimed in claim 17, wherein the second communication link between the charging control device of the vehicle and the authorization server is set up via the charging station.

20. The method as claimed in claim 19, wherein the second communication link between the charging control device of the vehicle and the authorization server is set up by tunneling via the first communication link, which exists between the charging control device of the vehicle and the charging station.

21. The method as claimed in claim 17, wherein the second communication link between the charging control device of the vehicle and the authorization server is cryptographically protected.

22. The method as claimed in claim 17, wherein the authorization check result specifies filtering rules for data communications via the first communication link between the charging control device of the vehicle and the charging station.

23. The method as claimed in claim 22, wherein the filtering rules contain parameters relating to communication addresses, protocols or ports.

24. The method as claimed in claim 22, wherein the authorization check result has control data identifying which filtering rules should be activated by the charging control device.

25. The method as claimed in claim 17, wherein the authorization check result specifies charging rules to control charging of the accumulator in the vehicle by the charging station.

26. The method as claimed in claim 17, wherein
the charging control device charges the accumulator in the vehicle, as a function of charging rules specified in the authorization check result, and
the charging control unit charges the accumulator in the vehicle using electrical energy transmitted from the charging station to the vehicle.

27. The method as claimed in claim 26, wherein the charging station charges the accumulator in the vehicle through a charging cable or by inductive energy transmission.

28. The method as claimed in claim 27, wherein
the charging station charges the accumulator in the vehicle through the charging cable, and
the first communication link between the charging control device of the vehicle and the charging station is established via the charging cable by Power Line Communication (PLC).

29. The method as claimed in claim 27, wherein
the charging station charges the accumulator in the vehicle through the charging cable, and
the first communication link between the charging control device of the vehicle and the charging station is established via a data line which runs in parallel with the charging cable or via a data line which is integrated into the charging cable.

30. The method as claimed in claim 27, wherein the first communication link between the charging control device of the vehicle and the charging station is established via a radio interface.

31. A charging control device for a vehicle, to control charging of an accumulator in the vehicle by a charging station, comprising:
a calculation unit to provisionally verify a digital certificate for the charging station, the digital certificate being received from the charging station via a first communication link, which is cryptographically protected;
a transmitter to transmit information from the digital certificate, the information being transmitted after the digital certificate has been provisionally verified, the information being transmitted to an authorization server via a second communication link, for determining an authorization check result; and
a receiver to receive the authorization check result from the authorization server via the second communication link,
wherein the charging control device controls a charging of the accumulator in the vehicle, by the charging station, as a function of the authorization check result.

32. The charging control device as claimed in claim 31, wherein
the charging station charges the accumulator in the vehicle, through a charging cable or by inductive energy transmission, and
the charging station charges the accumulator in the vehicle in accordance with charging rules specified in the authorization check result.

33. The charging control device as claimed in claim 31, wherein the first communication link between the charging control device and the charging station is via a charging cable using Powerline Communication (PLC) or via a data line running parallel to the charging cable or via a radio interface.

34. An electric vehicle comprising:
an electric motor;
an accumulator to store electrical energy for the electric motor; and
a charging control device to control charging of the accumulator by a charging station, comprising:
a calculation unit to provisionally verify a digital certificate for the charging station, the digital certificate being received from the charging station via a first communication link, which is cryptographically protected;
a transmitter to transmit information from the digital certificate, the information being transmitted after the digital certificate has been provisionally verified, the information being transmitted to an authorization server via a second communication link, for determining an authorization check result; and
a receiver to receive the authorization check result from the authorization server via the second communication link,
wherein the charging control device controls charging of the accumulator in the vehicle, by the charging station, as a function of the authorization check result.
